(19) United States
(12) Patent Application Publication
(10) Pub. No.: US 2026/0098133 A1
(43) Pub. Date: Apr. 9, 2026

(54) Ethylene Polymer Layers And Layered Films Made Therefrom

(71) Applicant: ExxonMobil Chemical Patents Inc., Spring, TX (US)

(72) Inventors: Li SHI, Shanhai (CN); Zeng Zeng YAO, Shanghai (CN); Xiao-Chuan WANG, Shanghai (CN); Qi TANG, Shanhai (CN); Lu Ying REN, Shanhai (CN)

(21) Appl. No.: 19/113,276

(22) PCT Filed: Oct. 16, 2023
(86) PCT No.: PCT/US2023/076949

§ 371 Date: Mar. 19, 2025

Related U.S. Application Data
(60) Provisional application No. 63/382,394, filed on Nov. 4, 2022.

(51) Int. Cl. C08J 5/18; C08J 3/22; C08J 9/16

(52) U.S. Cl. CPC C08J 5/18; C08J 3/22; C08J 9/16; C08J 2201/03; C08J 2323/08; C08J 2433/12; C08J 2433/20

(57) ABSTRACT

Ethylene polymer and copolymer layered greenhouse film compositions comprising thermoexpandable microcells exhibiting enhanced thermicity and manufacturing methods related thereto. A greenhouse film composition including at least one foamable film layer composition comprising a thermal expandable microsphere masterbatch component and an ethylene-based polymer component, wherein the greenhouse film comprises less than 20% by weight of a total of one or both of ethylene vinyl acetate or ethylene acetyl acetate.

### FIELD OF INVENTION

The present disclosure relates to ethylene-based polymer and copolymer layered film compositions and manufacturing methods related thereto. In particular, the present disclosure relates to ethylene polymer and copolymer layered greenhouse film compositions comprising thermo-expandable microcells exhibiting enhanced thermicity and manufacturing methods related thereto.

### BACKGROUND OF THE INVENTION

Greenhouse structures absorb energy during the day from visible and infrared (IR) light from the sun. During the night, heat is released in the form of long-wavelength IR radiation to cooler outside air. Greenhouse films and low-tunnel cover are used to tent greenhouse structures to reduce the amount of IR energy lost during the night. Accordingly, greenhouse films require high heat retention (i.e., high thermicity), a measure of the transmission of IR electromagnetic radiation through the film to retain heat during the night for agricultural growth of plants. High thermicity means high retention of heat; a chart is used to depict thermicity upon testing, wherein the Y-axis reflects the transmission of heat (as opposed to the retention of heat). Typically, greenhouse films that reduce long-wavelength radiation to less than at least about 60% are desirable. Further, greenhouse films are beneficial for diffused light in situations where direct sunlight into a greenhouse structure is undesirable.

Greenhouse films that are anti-dripping also aid in the effectiveness of greenhouse films, particularly in locations having one or both of high humidity and high temperature. The anti-dripping quality limits the formation of water droplets that can reduce light transmission into a greenhouse structure and is typically achieved using nonionic surfactants that over time can be consumed and thus fail to achieve the desired benefits over time.

Conventional greenhouse films use ethylene vinyl acetate (EVA) polymers as a primary material and may further include various filler material, such as talc, silica, or other minerals. EVA polymers are effective at producing greenhouse films that can block long-wavelength IR energy loss and reduce cooling of a greenhouse structure during the night. However, EVA polymer supply can be hampered due to manufacturing hindrances. For example, high VA % EVA greenhouse films that are most effective at blocking long-wavelength IR energy loss from greenhouse structures are sticky and may exhibit poor creep resistance. Moreover, EVA pricing can fluctuate widely, which may result in prohibitive greenhouse film costs. Filler materials may be included, such as talc, which aid in thermicity, and exhibit similar or less thermicity compared to EVA. The use of such filler materials, however, may significantly impact the recyclability of the films due to the inorganic nature of the material.

Thus, there is a need for greenhouse films that exhibit suitable thermicity and anti-dripping qualities with reduced or eliminated EVA polymer use.

Some references of potential interest in this regard include: U.S. Pat. Nos. 6,235,800; 9,776,157; US 2013/0101826; CA 2945117; WO 2014/202605; WO 2020/023207; and EP 3880467.

### SUMMARY OF THE INVENTION

In one or more aspects, the present disclosure provides a greenhouse film composition comprising at least one foamable film layer composition including a thermal expandable microsphere masterbatch component and an ethylene-based polymer component, wherein the greenhouse film comprises less than 20% by weight of a total of one or both of ethylene vinyl acetate or ethylene acetyl acetate.

In one or more aspects, the present disclosure provides a method comprising preparing at least one film layer composition by blending a thermal expandable microsphere masterbatch component and an ethylene-based polymer component, wherein the ethylene-based polymer component comprises less than 20% by weight of a total of one or both of ethylene vinyl acetate or ethylene acetyl acetate; and extruding the blend by blown line film extrusion at a temperature in the range of about 50° C. to about 200° C.

In one or more aspects, the present disclosure provides a system comprising a greenhouse framework; and a greenhouse film spread over or otherwise connected to the greenhouse framework, the greenhouse film including at least one foamable film layer composition comprising a thermal expandable microsphere masterbatch component and an ethylene-based polymer component, wherein the greenhouse film comprises less than 20% by weight of a total of one or both of ethylene vinyl acetate or ethylene acetyl acetate.

### BRIEF DESCRIPTION OF THE DRAWINGS

The following figures are included to illustrate certain aspects of the layered films of the present disclosure, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is an illustration of a mono-layer foamable film structure process, according to one or more aspects of the present disclosure.

FIGS. 2A and 2B are illustrations of a multi-layer film structures processes comprising 3-layers, according to one or more aspects of the present disclosure.

FIG. 3 and FIG. 4 are illustrations of multi-layer film structures comprises comprising 5-layers after extrusion, according to one or more aspects of the present disclosure.

FIG. 5A is an image of a film lacking TEM masterbatch. FIG. 5B is an image of a film comprising TEM masterbatch, according to one or more aspects of the present disclosure.

### DETAILED DESCRIPTION

Before the present compounds, components, compositions, and/or methods are disclosed and described, it is to be understood that unless otherwise indicated this invention is not limited to specific compounds, components, compositions, reactants, reaction conditions, ligands, or the like, as such may vary, unless otherwise specified.

In one or more aspects, the present disclosure is directed to mono- or multi-layered films (referred to collectively as “layered” films) and methods for manufacturing layered films exhibiting thermicity and anti-dripping qualities. The layered films may be used as greenhouse films for covering greenhouse structures. The layered films described herein may be produced using conventional blown line film extrusion processes with no extra adaptation and comprise thermal expandable microspheres (TEM) in the form of masterbatch to generate bubbles during the film extrusion process. By adjusting the size, dosage, and matrix of the TEM masterbatch within one or more ethylene-based polymer film layers, the layered films of the present disclosure can be optimized to achieve desired or enhanced thermicity and anti-dripping qualities. The layered films of the present disclosure exhibit qualities comparable or better than conventional EVA greenhouse films.

One or more illustrative embodiments incorporating the embodiments of the present disclosure are included and presented herein. Not all features of a physical implementation are necessarily described or shown in this application for the sake of clarity. It is understood that in the development of a physical embodiment incorporating the embodiments of the present disclosure, numerous implementation-specific decisions must be made to achieve the developer's goals, such as compliance with system-related, business-related, government-related, and other constraints, which vary by implementation and from time to time. While a developer's efforts might be time-consuming, such efforts would be, nevertheless, a routine undertaking for those of ordinary skill in the art and having benefit of this disclosure.

Unless otherwise indicated, all numbers expressing quantities of ingredients, properties such as physical properties, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

When numerical lower limits and numerical upper limits are listed herein, ranges from any lower limit to any upper limit are contemplated, whether or not explicitly listed.

While compositions and methods are described herein in terms of “comprising” various components or steps, the compositions and methods can also “consist essentially of” or “consist of” the various components and steps.

All priority documents, patents, publications, and patent applications, test procedures (such as ASTM methods), and other documents cited herein are fully incorporated by reference to the extent such disclosure is not inconsistent with this disclosure and for all jurisdictions in which such incorporation is permitted.

Various terms as used herein are defined below. To the extent a term used in a claim is not defined below, it should be given the broadest definition persons in the pertinent art have given that term as reflected in one or more printed publications or issued patents.

### Definitions

As used herein, the term “copolymer,” and grammatical variants thereof, is meant to include polymers having two or more monomers. The term “polymer,” and grammatical variants thereof, as used herein includes, but is not limited to, homopolymers, copolymers, terpolymers, etc., and alloys and blends thereof. The term “terpolymer” as used herein refers to a polymer synthesized from three different monomers. Terpolymers, in some aspects, may be produced (1) by mixing all three monomers at the same time or (2) by sequential introduction of the different comonomers. The mixing of comonomers may be done in one, two, or possibly three different reactors in series and/or in parallel. The term “polymer” as used herein also includes impact, block, graft, random, and alternating copolymers. The term “polymer” shall further include all possible geometrical configurations unless otherwise specifically stated. Such configurations may include isotactic, syndiotactic, and random (i.e., atactic) symmetries.

The term “monomer” or “comonomer,” and grammatical variants thereof, as used herein, can refer to the monomer used to form the polymer, i.e., the unreacted chemical compound in the form prior to polymerization, and can also refer to the monomer after it has been incorporated into the polymer, also referred to herein as a “[monomer]-derived unit”. The primary monomers discussed herein include ethylene monomers. Similarly, when a polymer or copolymer is referred to as including an olefin, e.g., ethylene and at least one C₃ to C₂₀ α-olefin, the olefin present in such polymer or copolymer is the polymerized form of the olefin. For example, when a copolymer is said to have an “ethylene” content of 35 wt. % to 55 wt. % (or an ethylene monomer content of 35 wt. % to 55 wt. %), it is understood that the repeating unit/mer unit or simply unit in the copolymer is derived from ethylene in the polymerization reaction and the derived units are present at 35 wt. % to 55 wt. %, based on a weight of the copolymer. For the purposes of the present disclosure, ethylene shall be considered an α-olefin.

As used herein, the term “linear,” and grammatical variants thereof, relative to a polymer means a polymer having no detectable branching (quantitatively or qualitatively), preferably a long-chain branching factor of 1.0 (+0.02).

The term “blend” or “polymer blend,” and grammatical variants thereof, as used herein refers to a mixture of two or more polymers, including one or more polymers and polymeric thermal expandable microspheres. Blends may be produced by, for example, solution blending, melt mixing, or compounding in a shear mixer.

As used herein, the term “masterbatch,” and grammatical variants thereof, refers to a concentrated mixture of additives, in this case at least a thermal expandable microsphere and a polymer carrier, as described according to various aspects of the present disclosure. The masterbatch may be cooled and pelletized or otherwise cut or crushed, for example, into smaller particulates or desired sizes and shapes.

As used herein, the term “thermal expandable microspheres” or simply “TEM,” and grammatical variants thereof, refers to a pelletized expandable polymer shell (e.g., a thermoplastic shell) encapsulating a propellant. When heated, the TEMs expand to a size larger than their original non-heated size, such as up to about 50 times their original volume. The TEMs of the present disclosure act as foaming agents for forming bubbles within the layered films described herein. Examples of commercially available TEMs include, for example, MUCELL® products (Matsumoto Yushi-Seiyaku Co., Ltd., Yao, Osaka, Japan), such as MUCELL® 190SSPE comprising a TEM masterbatch having (1) 50 wt % of the TEM (a polymer shell of acrylonitrile copolymer (thickness of 2 micrometers (μm) to 15 μm) encapsulating a hydrocarbon propellant) in (2) 50 wt. % polymer carrier of polyethylene/methyl-methacrylate copolymer.

As used herein, the term “ethylene-based polymer” or “ethylene-based copolymer,” and grammatical variants thereof, refers to a polymer having the plurality of ethylene monomers, including up to 100% ethylene monomers. An “ethylene-based polymer carrier” refers to the ethylene-based polymer composition (and any blended or otherwise included additives thereto) with which the TEM masterbatches are blended. As used herein, the term “ethylene-based polymer” excludes ethylene vinyl acetate (EVA) and ethylene acetyl acetate (EAA), as described hereinbelow.

As used herein, the term “layered film” or “greenhouse film,” and grammatical variants thereof, refers to a mono- or multi-layered extruded film that comprises a blend of TEMs in masterbatch form component and an ethylene-based polymer component in at least one layer, the “foamed film layer composition.” A “foamable film layer composition” or simply “foamable layer composition,” and grammatical variants thereof, refers to the composition of the blend prior to extrusion. A “skin film layer composition” or “skin layer composition,” and grammatical variants thereof, refers to a composition of a layered film that lacks a TEM masterbatch component, and thus does not foam.

As used herein, the term “blown line film extrusion process,” “film extrusion process,” or simply “extrusion process,” refers to a film manufacturing process in which one or more (coextrusion) polymeric materials are processed through a single die using high heat.

The term “thermicity,” and grammatical variants thereof, as used herein, refers to a measure of the transmission of IR electromagnetic radiation through a film. Thermicity is determined herein using FTIR in accordance with EN 13206:2017.

The term “diffused light,” and grammatical variants hereof, as used herein, refers to a measure of haze and luminous transmittance of a film. Diffused light is determined herein in accordance with ASTM D1003: 2021. Diffused light may be used interchangeably with “haze.”

As used herein, the term “light transmission rate,” and grammatical variants thereof, refers to the percentage of light that goes through a film. Light transmission rate is determined herein in accordance with ASTM D-1003.

The term “anti-dripping,” and grammatical variants thereof, as used herein, refers to a quality that limits the formation of water droplets on a layered film. Anti-dripping is determined herein by means of surface tension, including testing methods ASTM D5946-04 and ISO 19403-2.

As used herein, the term “melt strength,” and grammatical variants thereof, refers to a measure of a polymer's resistance to its extensional deformation. Melt strength is determined herein based on Rheotens. Melt strength was measured per the present disclosure using a RHEO-TESTER 1000 (Göttfert Inc., South Carolina) at a temperature of 190° C., die of 30/2 mm, entrance angle of 180°, melting time of 300 s, piston speed of 0.5 mm/s, and shear rate of 72 s⁻¹; strand length of 122 mm and initial speed of 18 mm/s; Rheotens of 71.97, gap of 0.7 mm, and grooved wheels; and an acceleration of 12 mm/s². Melt strength is reported in Newtons (N).

### Film Layer Composition

The present disclosure provides a greenhouse film comprising: at least one foamable film layer composition comprising a TEM masterbatch component and an ethylene-based polymer component as described above. It is to be noted that the greenhouse films of the present disclosure may be used in other non-greenhouse applications requiring the thermicity, diffused light, anti-dripping, and other qualities of the layered films described herein, without departing from the scope of the present disclosure.

TEM masterbatches may comprise a TEM (polymer shell encapsulating a propellant) in a masterbatch carrier polymer.

Various monomers are suitable for the polymer shell of the TEMs and may include, but are not limited to, acrylonitrile, methacrylonitrile, α-haloacrylonitrile, α-ethoxyacrylonitrile, fumarc nitrile, an alkenyl aromatic monomer (e.g., styrene, o-methylstyrene, p-methylstyrene, m-methylstyrene, ethylstyrene, vinyl-xylene, bromostyrene, chlorostyrene, and the like), a vinyl bromide or other halogenated bromide, a vinyl ester (e.g., vinyl butyrate, vinyl stearate, vinyl laurate, vinyl propionate, vinyl myristate, and the like), and the like, and any combination thereof. The polymer shell generally has an expansion temperature (i.e., the glass transition temperature (Tg)) of from about 50° C. to about 200° C. depending on the composition of the polymer shell, encompassing any value and subset therebetween. The polymeric shell may have a thickness in the range of about 1 μm to about 20 μm, encompassing any value and subset therebetween.

The propellant for use in forming a TEM according to the present disclosure may be a single compound or multiple compounds. The propellant typically has a boiling temperature (for expansion) that is below the softening temperature of the polymer shell. The propellant may include a cyclic or aromatic hydrocarbon having between 1 and 18 carbons, encompassing any value and subset therebetween. Examples of suitable propellants may include, but are not limited to, ethane; propane; butane; isobutene; 2,3-dimethylbutane; pentene; isopentane; cyclopentane; 2-methylpentane; 3-methylpentane; n-hexane; isohexane; cyclohexane; heptane; isoheptane; octane; isooctane; decane; dodecane; isododecane; hexadecane; and the like; and any combination thereof.

The TEMs of the present disclosure may have an expansion such that expansion of the TEMs can be reliably (including completely) achieved without breaking the outer polymer shell (although it is recognized that some percentage, less than about 5%, may break, without departing from the scope of the present disclosure). The temperature in which expansion begins is the initiation temperature, or Tᵢₙᵢₜᵢₐₜᵢₒₙ, and the temperature at which maximum expansion is reached is the maximum temperature, or Tₘₐₓ. The Tᵢₙᵢₜᵢₐₜᵢₒₙ of the TEMs of the present disclosure may be in the range of about 70° C. to about 200° C., encompassing any value and subset therebetween, such as about 70° C. to about 160° C.; the Tₘₐₓ of the TEMs of the present disclosure is less than about 300° C., such as in the range of about 110° C. to about 300° C., encompassing any value and subset therebetween.

TEMs suitable for forming the masterbatch compositions of the present disclosure before expansion may have various average particle sizes. In one or more aspects, the average diameter of the TEMs before expansion may range from about 1 micrometer (μm) to about 500 μm, such as about 2 μm to about 300 μm, or about 4 μm to about 100 μm, or about from about 5 μm to about 50 μm, encompassing any value and subset therebetween (for example, ranges from any foregoing low end to any foregoing high end, such as about 2 μm to about 50 μm). The average diameter of the TEMs after expansion may range from about 2 to about 8 times their initial (non-expanded, non-extruded) average diameter size, such as in the range of about 2 μm to about 4000 μm, encompassing any value and subset therebetween.

The TEMs described herein may have a specific gravity upon expansion may exhibit low specific gravity, such as in the range of about 0.01 g/cc to about 0.035 g/cc, encompassing any value and subset therebetween, such as 0.02 g/cc to about 0.03 g/cc, or about 0.025 g/cc. In one or more aspects, the TEMs exhibit a specific gravity upon expansion of 0.025±0.05 g/cc or 0.25=0.01 g/cc.

The TEMs of the present disclosure preferably are provided in masterbatch form. Suitable masterbatch carrier polymers include thermoplastic resins, ethylene-based elastomers, or propylene-based elastomers. Examples of suitable masterbatch carrier polymers include, but are not limited to, polyethylene, polypropylene, ethylene/methacrylate copolymers, propylene/ethylene copolymers, propylene-α-olefin copolymers, ethylene vinyl acetate, and the like, and any combination thereof.

The concentration of TEMs within the masterbatch carrier polymer may be in the range of about 10 wt. % to about 70 wt. %, encompassing any value and subset therebetween (such as within the range from about 35, 40, or 45 wt % to 55, 60, or 65 wt %). In one or more aspects of the present disclosure, the concentration of TEMs within the masterbatch carrier polymer is equal to or about 50 wt. %.

The TEMs in masterbatch form are blended with an ethylene-based polymer component to form the foamable film layer compositions of the present disclosure, and thus the resultant greenhouse films.

The ethylene-based polymers for blending with the TEM masterbatches to form the foamable film layer compositions of the present disclosure are not considered to be particularly limiting and include, but are not limited to, low density polyethylenes (LDPE), linear low density polyethylene (LLDPE) (e.g., Ziegler-Natta LLDPE (ZN-LLDPE) or metallocene-catalyzed LLDPE (mLLDPE)), polypropylene, and any combination thereof (noting that LDPE and LLDPE can be ethylene homopolymers or ethylene copolymers, preferably LDPE can be either while the LLDPE is preferably an ethylene-α-olefin copolymer). For a polyethylene-α-olefin copolymer, the preferred α-olefin comonomer content is below about 30 weight percent (wt. %), preferably below about 20 wt. %, and more preferably from about 1 wt. % to about 15 wt. %. Preferred α-olefin comonomers include, but are not limited to, propylene, 1-butene, 1-pentene, 1-hexene, 3-methyl-1-pentene, 4-methyl-1-pentene, 1-octene, 1-decene, and 1-dodecene.

Examples of commercially available ethylene-based polymers include, but are not limited to, AFFINITY™ GA (a polyolefin elastomer, available from Dow Chemical Co.), AFFINITY™ GP (a polyolefin elastomer, available from Dow Chemical Co.), ENGAGE™ (a polyolefin elastomer, available from Dow Chemical Co.), DOWLEX™ (a polyethylene resin, available from Dow Chemical Co.), DOW™ LDPE (low density polyethylene, available from Dow Chemical Co.) (e.g., DOW™ LDPE 722), ELITE™ (a high α-olefin polyethylene resin, available from Dow Chemical Co.) (e.g., ELITE™ 5815, a metallocene LLDPE), EVOLUE™ (metallocene LLDPE, available from Mitsui Chemicals, Inc.), EXCEED™ (a polyethylene or polyethylene copolymer resin, available from ExxonMobil Chemical Company) (e.g., EXCEED™ 0019XC, ethylene 1-hexene copolymers), EXCEEDIM XP products (a polyethylene or polyethylene copolymer resin, available from ExxonMobil Chemical Company), ENABLE™ (a polyethylene or polyethylene copolymer resin, available from ExxonMobil Chemical Company), LD 165.BW1 (a low density polyethylene resin, available from ExxonMobil Chemical Company), and blends thereof.

It is to be noted that the greater the melt strength of a polymer, the greater the ability of the polymer to stabilize a foamable film layer composition (i.e., preventing the foam from deformation). However, mechanical properties also should be balanced to achieve a suitable foamable layer. In one or more aspects, the melt strength of the ethylene-based polymers of the present disclosure may be in the range of about 0.04 N to about 0.35 N, encompassing any value and subset therebetween, such as about 0.08 N to about 0.31 N, or about 0.1 N to about 0.2 N.

The amount of the TEMs in the masterbatch form, when present at a concentration of 40-60 wt % (preferably about 50 wt. %) thereof, may be blended with the ethylene-based polymer portion to form a foamable film layer composition in an amount in the range of about 0.5 wt. % to about 5 wt. % by the total weight of the film composition, encompassing any value and subset therebetween. This amount of TEM allows the TEM to foam and achieve the desired foam quality to produce a film having the desired physical properties (e.g., thermicity, diffused light value, anti-dripping). In one or more aspects, the TEM masterbatch may be present in a film composition in the range of from about 0.5 wt. % to about 2.5 wt. %, or about 1.5 wt. % to about 2.5 wt. %, or about 0.5 wt. % to about 1 wt. % (on basis of total weight of the film composition), encompassing any value and subset therebetween.

A multi-layered film may comprise a skin film layer composition comprising any one or a combination of the ethylene-based polymers described herein above with reference to the foamable film layer composition, without departing from the scope of the present disclosure.

In one or more aspects, either one or both of the foamed film composition and/or skin film composition may further comprise EVA or EAA, or a combination thereof. When included, EVA and/or EAA are in a combined concentration of less than 50 wt. % of the total layered film composition (i.e., the combination of all layers of the layered film together). In one or more aspects, any EVA and/or EAA is in the range of 0 wt. % to 50 wt. % of the total layered film composition, encompassing any value and subset therebetween, such as about 0 wt. % to about 40 wt. %, or about 0 wt. % to about 30 wt. %, or about 0 wt. % to about 20 wt. %, or about 0 wt. % to about 10 wt. %, or about 0 wt. % to about 5 wt. %, or about 0 wt. % to about 2.5 wt. %. In one or more specific aspects, any EVA and/or EAA present in the total film composition is in an amount of less than about 10 wt. %, or less than about 5 wt. %, or less than about 2.5 wt. %, or less than about 1.0 wt. %, or less than about 0.5 wt %, of the ethylene-based polymer portion of the film composition, encompassing any value and subset therebetween, including 0 wt. % (potentially allowing for trace amounts of EVA and/or EAA, such as less than 100 ppm by weight, which may be referred to as being “substantially free” of EVA and/or FAA). It is to be noted that EVA having a low percentage of vinyl acetate content, such as less than about 20 wt. % may be used with TEMs as described herein, without departing from the scope of the present disclosure.

The physical expansion of the TEMs described herein results in a layered film (after extrusion) having substantially closed and foamed cell structures, which provides the desired greenhouse film qualities described herein.

Accordingly, the present disclosure provides a greenhouse film comprising: at least one film layer composition comprising a thermal expandable masterbatch component and an ethylene-based polymer component as described above. In one or more aspects, the greenhouse film comprises EVA and/or EVA in an amount of less than 20 wt. % thereof in total.

### Extruded Layered Film Structures

The present disclosure provides a method of preparing the at least one foamable film layer composition including the steps of (1) blending a thermal expandable masterbatch component and the ethylene-based polymer component, and (2) extruding the blend by blown line film extrusion at a temperature in the range of about 50° C. to about 200° C. In one or more aspects, the greenhouse comprises EVA and/or EVA in an amount of less than 20 wt. % thereof in total.

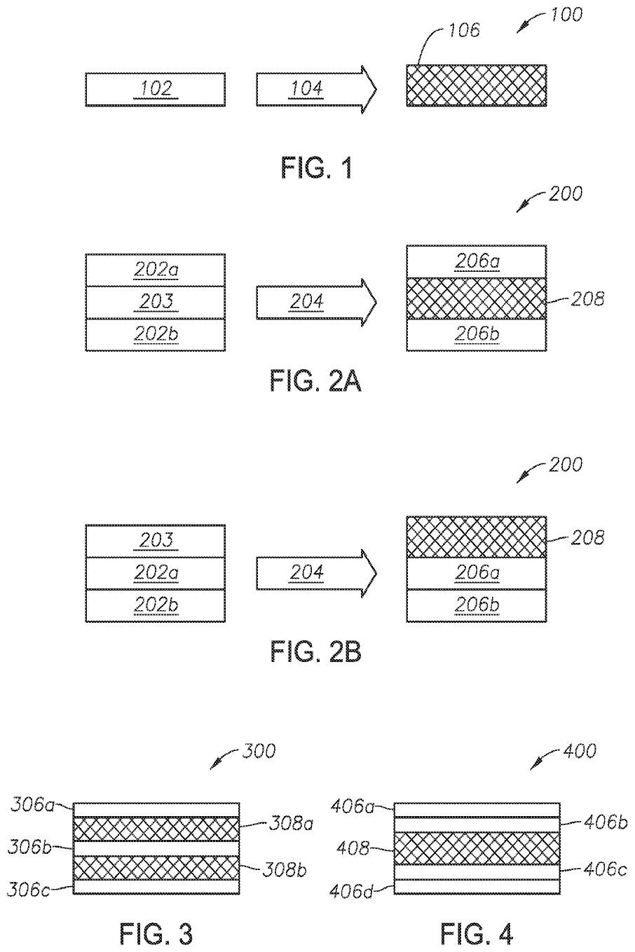

The layered films (e.g., mono-layered or multi-layered film structures, such as those shown in FIGS. 1-4) can be extruded by blown film extrusion. In one or more aspects, the layered films, when comprising multi-layers (i.e., one or more foamed layers and one or more skin layers), can be extruded by blown film coextrusion. A blown film coextrusion process can comprise: separately melting one or more foamable film layer compositions and one or more skin film layer compositions, extruding the corresponding melts in contact with one another, and cooling the layers to produce the layered film structure. The melted layer may pass through concentrically arranged spiral dies having a vertical orientation of spiral channels. Melt layers and/or skin layers may be joined together below the die exits to form multi-layer structures and thereafter cooled.

The blown film extrusion and coextrusion equipment and methods of the present disclosure can be used to achieve a target thickness or final thickness of the layered films of the present disclosure. The actual thickness in microns depends on the density of the composition in the film or film layer, the presence and amount of layers beyond a mono-layer, the resultant film's particular use or location of use (e.g., certain cooler climates may require a greenhouse film that is comparably less thick), and the amount of TEM masterbatch within the layered film. In one or more aspects, the thickness of the layered films of the present disclosure may be in the range of about 150 μm to about 400 μm, encompassing any value and subset therebetween, such as about 150 μm to about 350 μm, or about 150 μm to about 300 μm, or about 300 μm to about 400 μm.

Further, equipment variables that can affect the resultant layered film thickness include, but are not limited to, the die gap, melt temperature, the line speed, the melt pressure, and the screw speed (which relates to how fast the polymer is extruded from the die). Further, there can be variation in the degree each variable affects the resultant layer thickness between different pieces of equipment.

Typically, the extrusion temperature for the foamable film layer compositions and skin film layer compositions of the present disclosure may be in the range of about 150° C. to about 200° C., encompassing any value and subset therebetween, such as about 175° C. to about 180° C. The die temperature for the foamable film layer compositions and skin film layer compositions of the present disclosure may be in the range of about 200° C. to about 300° C., encompassing any value and subset therebetween, such as about 200° C. to about 250° C., or about 200° C. to about 220° C.

The extrusion or coextrusion line speed for industrial manufacturing of layered film of the present disclosure may be in the range of about 5 meters per minute (m/min) to about 20 m/min, encompassing any value and subset therebetween, such as about 5 m/min to about 10 m/min.

The extruded layered films of the present disclosure may exhibit a thermicity in the range of less than about 40%, including in the range of about 1% to about 40%, or about 1% to about 30% or about 1% to about 10%, encompassing any value and subset therebetween. Generally, the higher the concentration of TEM masterbatch within one or more foamable layers, the lower the thermicity value.

The extruded layered films of the present disclosure may exhibit total diffused light (total haze) in the range of about 50% to 100%, encompassing any value and subset therebetween, such as about 60% to 100%, or about 80% to 100%. Generally, the higher the concentration of TEM masterbatch within one or more foamable layers, the higher the total diffused light value.

In one or more aspects of the present disclosure, the extruded layered films described herein may comprise a light transmission rate (LTR) in the range of about 60% to about 90%, encompassing any value and subset therebetween, such as about 70% to about 90%. Generally, the higher the concentration of TEM masterbatch within one or more foamable layers, the lower the LTR.

The layered film structures of the present disclosure may comprise a foamed mono-layer or one or more foamed layers in combination with one or more skin layers.

### Layered Film Structures

FIG. 1 is an illustration of a mono-layer foamable film structure process 100. As shown, foamable film layer composition 102, upon extrusion 104, produces a foamed greenhouse film 106. The illustrated film structure process 100 may be performed using blown line extrusion, as provided hereinabove.

FIGS. 2A and 2B are illustrations of processes for forming a multi-layer film structure 200 comprising 3 layers. Like labeling between FIGS. 2A and 2B will be used for brevity. As shown in FIGS. 2A and 2B, foamable film layer composition has two non-foamable layer compositions (202a, 202b) and a single foamable layer composition 203. In FIG. 2A, the foamable film layer composition 203 is located as a “core” between two skin layer compositions 202a, 202b. In FIG. 2B, the foamable film layer 203 is located as an outer layer atop two skin layer compositions 202a, 202b. Upon extrusion 204, the foamed greenhouse film is produces foamed film layer 208 and extruded skin layers 206a, 206b.

FIG. 3 and FIG. 4 are illustrations of multi-layer film structures 300 and 400, respectively, each comprising 5-layers after extrusion. FIG. 3 shows a foamed film layer 308a sandwiched between skin layers 306a and 306b, and foamed film layer 308b sandwiched between skin layers 306a and 306c. The five-layer film structure forms a single film. FIG. 4 shows a single foamed film layer 408 sandwiched between two skin layers on either side, skin layers 406a, 406b on one side and skin layers 406c and 406d on the opposing side. The five-layer film structure forms a single film.

### Greenhouse Structure

In one or more aspects of the present disclosure, a greenhouse structure is provided comprising a greenhouse framework. The greenhouse framework may be any conventional framework for use as a greenhouse, regardless of size, shape, or material fabrication. A greenhouse film is provided in accordance with the various aspects of the present disclosure, as described above, for being spread over or connected directly or indirectly to the greenhouse framework.

### Example Embodiments

Nonlimiting example embodiments of the present disclosure include:

Embodiment A: A greenhouse film composition comprising: at least one foamable film layer composition comprising a thermal expandable microsphere masterbatch component and an ethylene-based polymer component, wherein the greenhouse film comprises less than 20% by weight of a total of one or both of ethylene vinyl acetate or ethylene acetyl acetate.

Embodiment B: A method comprising: preparing at least one greenhouse film layer composition by blending a thermal expandable microsphere masterbatch component and an ethylene-based polymer component, wherein the ethylene-based polymer component comprises less than 20% by weight of a total of one or both of ethylene vinyl acetate or ethylene acetyl acetate; and extruding the blend by blown line film extrusion at a temperature in the range of about 50° C. to about 200° C.

Embodiment C: A system comprising: a greenhouse framework; and a greenhouse film spread over or otherwise connected to the greenhouse framework, the greenhouse film comprising: at least one foamable film layer composition comprising a thermal expandable microsphere masterbatch component and an ethylene-based polymer component, wherein the greenhouse film comprises less than 20% by weight of a total of one or both of ethylene vinyl acetate or ethylene acetyl acetate.

Nonlimiting example embodiments A, B, or C may include one or more of the following elements:

Element 1: Wherein the greenhouse film has a thermicity of less than about 40%.

Element 2: Wherein the greenhouse film has a thermicity in the range of about 1% to about 40%.

Element 3: Wherein the ethylene-based polymer component comprises one or more of low-density polyethylene, linear low-density polyethylene, polyethylene-α-olefin copolymer, or polypropylene.

Element 4: Wherein the thermal expandable microsphere masterbatch component comprises a plurality of thermal expandable microspheres comprising a polymer shell encapsulating a propellant.

Element 5: Wherein the thermal expandable microsphere masterbatch component comprises a plurality of thermal expandable microspheres comprising a polymer shell encapsulating a propellant; and wherein the polymer shell comprises one or more of acrylonitrile, methacrylonitrile, α-haloacrylonitrile, α-ethoxyacrylonitrile, fumarc nitrile, an alkenyl aromatic monomer, a vinyl bromide or other halogenated bromide, or a vinyl ester.

Element 6: Wherein the thermal expandable microsphere masterbatch component comprises a plurality of thermal expandable microspheres comprising a polymer shell encapsulating a propellant; and wherein the propellant comprises a cyclic or aromatic hydrocarbon having between 1 and 18 carbons.

Element 7: Wherein the thermal expandable microsphere masterbatch component comprises a plurality of thermal expandable microspheres comprising a polymer shell encapsulating a propellant; and wherein the plurality of thermal expandable microspheres have a specific gravity in the range of about 0.01 g/cc to about 0.035 g/cc.

Element 8: Wherein the thermal expandable microsphere masterbatch component comprises 50 wt. % of a plurality of thermal expandable microspheres therein, and wherein the thermal expandable microsphere masterbatch component is present in the greenhouse film in the range of about 0.5 wt. % to about 5 wt. % of the greenhouse film.

Element 9: Wherein the greenhouse film has a thickness in the range of about 150 μm to about 400 μm.

Element 10: Wherein the ethylene-based polymer component has melt strength of about 0.04 N to about 0.35 N.

Embodiments A, B, and C may have any one, more, or all of Elements 1-10 in any combination, without limitation.

To facilitate a better understanding of the embodiments of the present invention, the following examples of preferred or representative embodiments are given. In no way should the following examples be read to limit, or to define, the scope of the invention.

### EXAMPLES

### Layered Film Preparation

Example 1. Various 3-layer films were prepared by blown film coextrusion, according to Table 1. Film C₁ is a control without a foamable film layer composition, whereas Samples E1-E3 are experimental samples comprising either 0.5 wt. % of TEM masterbatch per total weight of the film in a core layer (E1), 0.5 wt. % of TEM masterbatch per total weight of the film in a single outer layer (E2), or 0.5 wt. % of TEM masterbatch per total weight of the film in an outer layer (E3). The TEM was MUCELL® 190SSPE, as described above, a masterbatch comprising 50 wt. % of the TEM in 50 wt. % carrier resin. The outer layer, inner layer, or core layer comprised of one or more of EXCEED™ XP 6056 (a low density polyethylene 1-hexane copolymer, available from ExxonMobil Chemical Company), EXCEED™ XP 6026 (a linear low density polyethylene 1-hexane copolymer, available from ExxonMobil Chemical Company), LD 165.BW1 (a low density polyethylene resin, available from ExxonMobil Chemical Company), or LL 1001AV (an ethylene 1-butene linear low density polyethylene resin, available from Exxon Mobil Chemical Company), as provided in Table 1.

As mentioned above, the greater the melt strength of a polymer, the greater the ability of the polymer to stabilize a foamable film layer composition (i.e., preventing the foam from deformation). For example, EXCEED™ XP 6026 (melt strength of 0.10N) and EXCEED™ XP 6056 (melt strength 0.08N) have higher melt strength and toughness (tensile strength) while also still providing excellent mechanical toughness, compared other polymers. Moreover, along with the melt strength, they also possess longer molecular chain branching, which further assists in stabilizing foamed bubbles.

TABLE 1

| Sample | C1 | E1 | E2 | E3 |
|---|---|---|---|---|
| Description | Reference | Foamed film | Foamed film | Foamed film |
| | film without | containing 0.5% | containing 0.5% | containing 0.25% |
| | foaming | TEM, | TEM, | TEM, |
| | | concentrated in | concentrated in | concentrated in 2 |
| | | core layer | one skin layer | skin layers |
| Film thickness | 150 μm | 180 μm | 185 μm | 195 μm |
| Foam ratio in | 0 | 2.8 | 1.7 | 1.4 |
| the foaming | | | | |
| layer | | | | |
| Layer | 1/1/1 | 1/2.8/1 | 1.7/1/1 | 1.4/1/1.4 |
| distribution | | | | |
| Outer Layer | (1) 100% | (1) 100% Exceed | (1) 98.5% | (1) 99.25% |
| | Exceed XP | XP 6056 | Exceed XP 6056 | Exceed XP 6056 |
| | 6056 | | (2) 1.5% TEM | (2) 0.75% TEM |
| Core Layer | (1) 60% | (1) 59% LD | (1) 60% Exceed | (1) 60% Exceed |
| | Exceed XP | 165.BW1 | XP 6026 | XP 6026 |
| | 6026 | (2) 40% LL | (2) 40% LD | (2) 40% LD |
| | (2) 40% LD | 1001AV | 165.BW1 | 165.BW1 |
| | 165.BW1 | (3) 1% TEM | | |
| Inner Layer | (1) 100% | (1) 100% Exceed | (1) 100% Exceed | (1) 99.25% |
| | Exceed XP | XP 6056 | XP 6056 | Exceed XP 6056 |
| | 6056 | | | (2) 0.75% TEM |

Each of the samples were processed using a JINMING International Co. (Guangdong, China) blown line film extruder at an extrusion temperature of about 175° C.-180° C. and a die temperature of 210° C., with a speed of 7 m/min. The diffused light, LTR, and thermicity were measured as provided herein. The results are provided in Table 2.

TABLE 2

| | | | | Thermicity |
|---|---|---|---|---|
| Sample | Thickness (μm) | Total Haze (%) | LTR (%) | (%) |
| C1 | 150 | 11.9 | 92.4 | 64.80 |
| E1 | 180 | 55.7 | 86.20 | 30.18 |
| E2 | 185 | 69.9 | 87.2 | 26.50 |
| E3 | 195 | 67.1 | 86.8 | 31.40 |

As shown, the haze increased and the thermicity decreased advantageously with the addition of TEM masterbatch in all layers of a 3-layer greenhouse film. The LTR remained substantially similar to the control sample.

Example 2. Various three-layer films (C₂, E4-E7) were prepared by blown film coextrusion, according to Table 3. Film C₂ is a control without a foamable film layer composition, whereas Samples E4-E7 are experimental samples comprising between 0.5 wt. % to 4 wt. % of TEM masterbatch per total weight of the film in a core layer. The TEM was MUCELL® 190SSPE, as described above, in 50 wt. % masterbatch.

TABLE 3

| Sample | C2 | E4 | E5 | E6 | E7 |
|---|---|---|---|---|---|
| Description | Without | Foamed film | Foamed film | Foamed film | Foamed film |
| | foam | containing | containing | containing | containing |
| | | 0.5% TEM | 1% TEM in | 2% TEM in | 4% TEM in |
| | | in core layer | core layer | core layer | core layer |
| Film | 150 μm | 165 μm | 180 μm | 220 μm | 260 μm |
| thickness | | | | | |
| Layer | 1/2/1 | 1/1.4/1 | 1/1.8/1 | 1/2.9/1 | 1/3.9/1 |
| distribution | | | | | |
| Outer Layer | 100% | 100% | 100% | 100% | 100% |
| | XP6056 | XP6056 | XP6056 | XP6056 | XP6056 |
| Core Layer | (1) 60% XP | (1) 61% | (1) 59% | (1) 60% | (1) 60% |
| | 6026 | Enable 2203 | LD165BW1 | XP6026 | XP6026 |
| | (2) 40% | (2) 38.5% | (2) 40% | (2) 38% | (2) 36% |
| | LD165BW1 | LD165BW1 | LL1001AV | LD165BW1 | LD165BW1 |
| | | (3) 0.5% | (3) 1% TEM | (3) 2% TEM | (3) 4% TEM |
| | | TEM | | | |
| Inner Layer | 100% | 100% | 100% | 100% | 100% |
| | XP6056 | XP6056 | XP6056 | XP6056 | XP6056 |

Each of the samples were processed using a JINMING International Co. (Guangdong, China) blown line film extruder at an extrusion temperature of about 175° C.-180° C. and a die temperature of 210° C., with a speed of 7 m/min. The diffused light, LTR, and thermicity were measured as provided herein. The results are provided in Table 4.

TABLE 4

| | | | | Thermicity |
|---|---|---|---|---|
| Sample | Thickness (μm) | Total Haze (%) | LTR (%) | (%) |
| C2 | 150 | 11.8 | 92.3 | 64.18 |
| E4 | 165 | 26.1 | 90.3 | 49.96 |
| E5 | 180 | 55.7 | 86.2 | 30.18 |
| E6 | 220 | 91.9 | 75.3 | 6.76 |
| E7 | 260 | 100 | 60.6 | 1.06 |

Similar to the results in Table 2, the haze increased and the thermicity decreased advantageously with the addition of TEM masterbatch in all layers of a 3-layer greenhouse film. The LTR remained substantially similar to the control sample, though began to decline with increasing TEM masterbatch concentration. As provided in Table 4, the evolution of thermicity, haze, and LTR with the increase of TEM dosage can be observed.

Example 3. The thermicity (IR transmission) of films comprising low-density polyethylene (density 0.923 g/cc) (LDPE) were compared to ethylene vinyl acetate (18% vinyl acetate) (EVA), at various thicknesses. The films were prepared as described in Examples 1 and 2. The results are shown in Table 5.

TABLE 5

Thermicity (%)

| Thickness (μm) | LDPE | EVA |
|---|---|---|
| 50 | 80.5 | 49.5 |
| 75 | 75.8 | 39.8 |
| 100 | 72.4 | 32.2 |

As shown, while the thermicity of EVA is lower compared to LDPE alone, the inclusion of TEM masterbatch (see Examples 1 and 2) substantially decreases the thermicity of such ethylene-based polymer films without the use of EVA.

Example 4. The surface tension of a layered film according to the present disclosure was evaluated for anti-dripping as described above, compared to a control (C₃) having no TEM masterbatch. Each film was 80 μm thick and field test measured. The films were prepared by blown film coextrusion, according to Table 6.

TABLE 6

| Sample | C3 | E8 |
|---|---|---|
| Composition | (1) 30% XP 6026 | (1) 30% XP 6026 |
| | (2) 15% LDPE | (2) 15% LDPE |
| | (3) 55% LLDPE | (3) 44.5% LLDPE |
| | | (4) 0.5% TEM |
| Layer distribution | Mono film | Mono film |
| Thickness | 80 μm | 90 μm |

The surface energy (mN/m) and water contact angle) (°) are provided in Table 7.

TABLE 7

| | | Water Contact |
|---|---|---|
| TEM Masterbatch (%) | Surface Energy (mN/m) | Angle (°) |
| 0% | 31.04 +− 1.24 | 104 |
| 1.0% | 37.48 +− 8.03 | 80 |

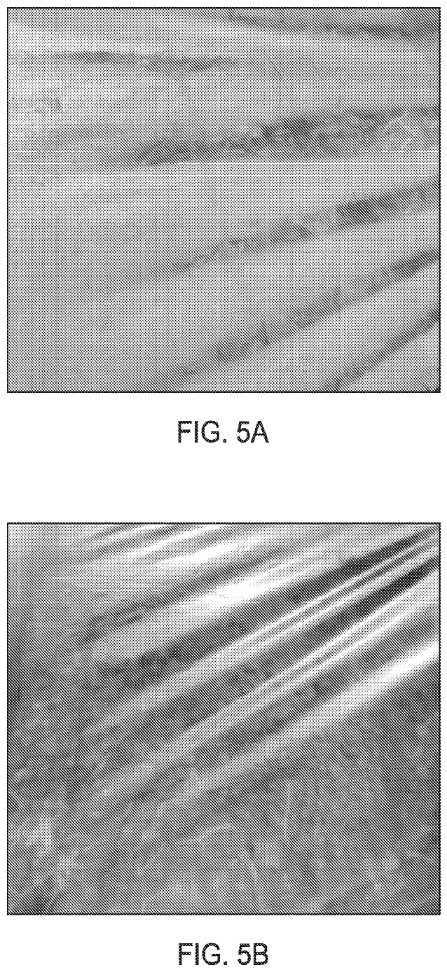

As shown, the sample comprising the TEM masterbatch exhibits superior anti-dripping qualities. The results are shown in FIG. 5A (no TEM masterbatch) and 5B (comprising TEM masterbatch).

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A greenhouse film composition comprising:
at least one foamable film layer composition comprising a thermal expandable microsphere masterbatch component and an ethylene-based polymer component, wherein the greenhouse film comprises less than 20% by weight of a total of one or both of ethylene vinyl acetate or ethylene acetyl acetate.

2. The greenhouse film of claim 1, wherein the greenhouse film has a thermicity of less than about 40%.

3. The greenhouse film of claim 2, wherein the greenhouse film has a thermicity of less than 30%.

4. The greenhouse film of claim 1, wherein the ethylene-based polymer component comprises one or more of low-density polyethylene, linear low-density polyethylene, polyethylene-α-olefin copolymer, or polypropylene.

5. The greenhouse film of claim 1, wherein the thermal expandable microsphere masterbatch component comprises a plurality of thermal expandable microspheres comprising a polymer shell encapsulating a propellant.

6. The greenhouse film of claim 5, wherein the polymer shell comprises one or more of acrylonitrile, methacrylonitrile, α-haloacrylonitrile, α-ethoxyacrylonitrile, fumarc nitrile, an alkenyl aromatic monomer, a vinyl bromide or other halogenated bromide, or a vinyl ester; and wherein the propellant comprises a cyclic or aromatic hydrocarbon having between 1 and 18 carbons.

7. The greenhouse film of claim 1, comprising less than 5% by weight of a total of one or both of ethylene vinyl acetate and ethylene acetyl acetate.

8. The greenhouse film of claim 7, comprising less than 100 ppm by weight of the total of one or both of ethylene vinyl acetate and ethylene acetyl acetate.

9. The greenhouse film of claim 1, wherein the ethylene-based polymer component has a melt strength of about 0.04 N to about 0.35 N.

10. The greenhouse film of claim 1, wherein the thermal expandable microsphere masterbatch component comprises 50 wt. % of a plurality of thermal expandable microspheres therein, and wherein the thermal expandable microsphere masterbatch component is present in the greenhouse film in the range of about 0.5 wt. % to about 5 wt. % of the greenhouse film.

11. The greenhouse film of claim 1, wherein the greenhouse film has a thickness in the range of about 150 μm to about 400 μm.

12. A method comprising:
preparing at least one greenhouse film layer composition by blending a thermal expandable microsphere masterbatch component and an ethylene-based polymer component, wherein the ethylene-based polymer component comprises less than 20% by weight of a total of one or both of ethylene vinyl acetate or ethylene acetyl acetate; and
extruding the blend by blown line film extrusion at a temperature in the range of about 50° C. to about 200° C.

13. The method of claim 12, wherein the greenhouse film has a thermicity of less than about 40%.

14. The method of claim 13, wherein the greenhouse film has a thermicity of less than 30%.

15. The method of claim 12, wherein the ethylene-based polymer component comprises one or more of low-density polyethylene, linear low-density polyethylene, polyethylene-α-olefin copolymer, or polypropylene.

16. The method of claim 12, wherein the thermal expandable microsphere masterbatch component comprises a plurality of thermal expandable microspheres comprising a polymer shell encapsulating a propellant.

17. The method of claim 16, wherein the polymer shell comprises one or more of acrylonitrile, methacrylonitrile, α-haloacrylonitrile, α-ethoxyacrylonitrile, fumarc nitrile, an alkenyl aromatic monomer, a vinyl bromide or other halogenated bromide, or a vinyl ester; and wherein the propellant comprises a cyclic or aromatic hydrocarbon having between 1 and 18 carbons.

18. The method of claim 12, wherein the ethylene-based polymer component comprises less than 5% by weight of a total of one or both of ethylene vinyl acetate or ethylene acetyl acetate.

19. The method of claim 12, wherein the ethylene-based polymer component has melt strength of about 0.04 N to about 0.35 N.

20. The method of claim 12, wherein the thermal expandable microsphere masterbatch component comprises 50 wt. % of a plurality of thermal expandable microspheres therein, and wherein the thermal expandable microsphere masterbatch component is present in the greenhouse film in the range of about 0.5 wt. % to about 5 wt. % of the greenhouse film.

21. A system comprising:
a greenhouse framework; and
a greenhouse film spread over or otherwise connected to the greenhouse framework, the greenhouse film comprising:
at least one foamable film layer composition comprising a thermal expandable microsphere masterbatch component and an ethylene-based polymer component, wherein the greenhouse film comprises less than 20% by weight of a total of one or both of ethylene vinyl acetate or ethylene acetyl acetate.
